(19) United States
(12) Patent Application Publication
(10) Pub. No.: US 2020/0340856 A1
(43) Pub. Date: Oct. 29, 2020

(54) DUAL-BAND SPECTRAL IMAGING SYSTEM BASED ON DIGITAL MICROMIRROR DEVICE AND IMPLEMENTATION METHOD THEREOF

(71) Applicant: Northwestern Polytechnical University, Xi'an (CN)

(72) Inventors: Yiting YU, Xi'an (CN); Xue DONG, Xi'an (CN); Xingchen XIAO, Xi'an (CN); Guangyao WANG, Xi'an (CN); Yining PAN, Xi'an (CN)

(73) Assignee: Northwestern Polytechnical University, Xi'an (CN)

(21) Appl. No.: 16/851,356

(22) Filed: Apr. 17, 2020

(30) Foreign Application Priority Data
Apr. 23, 2019 (CN) 201910328550.9

(51) Int. Cl. G01J 3/02; G01J 3/28; G02B 26/10; G02B 26/08

(52) U.S. Cl. CPC G01J 3/021; G01J 3/0208; G01J 2003/2826; G02B 26/101; G02B 26/0833; G01J 3/2823

(57) ABSTRACT

The invention discloses a dual-band spectral imaging system based on a digital micromirror device (DMD) and an implementation method thereof. The system mainly comprises a front collimating light path composed of a target 1, a front collimating lens assembly 2 and a DMD 3, and two spectral dispersion light paths with different working wave bands. A target image can be divided into columns by n micromirror scanning units of the DMD 3, and bidirectional scanning of the target image is realized by controlling the n micromirror scanning units to deflect forward and backward in sequence, so that detectors of the two spectral dispersion light paths are each provided with n dispersive spectral images. Then spectral reconstruction is completed according to the principle that each spectral image corresponds to a different target image unit, thereby the dual-band spectral information of a target scene is obtained.

### TECHNICAL FIELD

The invention belongs to the field of spectral imaging, and mainly relates to the micro-electromechanical system technology, the spectral imaging technology, the spectral image multi-band fusion processing technology and the like.

### BACKGROUND

For remote sensing in the wide fields of aerospace, food quality detection and intelligent medical diagnosis, it is often necessary to collect spectral information of multiple spectral bands of a target scene or sample. The comparison and fusion of the spectral information makes it much more effective in target identification, classification and tracking. However, these requirements cannot be met by single-band spectral imaging systems.

Due to the limitation of working wave bands of detectors and spectroscopic elements, it seems difficult for spectral imaging systems to detect the spectral information of multiple bands in one light path directly. At present, optical elements such as a beam splitter (CN102103265A, etc.), a spectroscope (CN104793324A, etc.) and a color splitter (CN101551272A, etc.) are widely used in systems capable of acquiring dual-band spectral information, so that incident light is divided into the transmission part and the reflection part, and then enters different light paths for dispersion, finally the spectral information is collected by different detectors. According to this method, the light energy entering the system is divided into two parts, so the light energy entering the subsequent sub-light paths is weakened; besides, the absorption of light energy is inevitable during transmission, resulting in loss of light energy. Therefore, this method will weaken useful light signals and is susceptible for the practical factors such as stray light, resulting in a decrease in signal-to-noise ratio (SNR). Especially, when the incident light signal of a detection target is weak, effective spectral information is even more difficult to extract. To overcome the above problems, Sun Qiang et al. (CN 101813521A) from Changchun Institute of Optics, Fine Mechanics and Physics used a stepping motor to power two detectors, so as to alternately collect dual-band spectral information generated by a harmonic diffractive lens. This method avoids the problem of splitting incident light. However, the existence of the stepping motor and a sliding table makes the whole machine bulky, heavy, poor in stability and low in compactness, which is not conducive to the portability of the system.

Thanks to the rapid development of microelectromechanical systems (MEMS) technology, digital micromirror devices (DMD), as a successful product of this technology, have been widely applied in the field of digital light processing (DLP). A working surface of the DMD is mainly composed of many micromirror arrays of micron sizes. Each micromirror can be program-controlled to deflect diagonally around its mirror surface, as shown in FIG. 1. There are only two deflection states, that is, forward deflection and backward deflection, which own the same deflection angles but opposite directions, e.g., ±12°. Different deflection states of the micromirror can make the light incident thereon reflect off in different exit directions. Meanwhile, each micromirror has the fast switching speed, which makes it an excellent spatial light modulator. Many researchers have tried to apply the DMD to the field of spectral imaging.

At present, the DMD can be used as a one-way scanner in a single-band spectral imaging system (CN 105527021A). By means of the forward deflection or backward deflection function of the DMD, point-by-point scanning or column-by-column scanning of target spatial information in a single direction is realized, but the function of bidirectional deflection is not involved in the process. In addition, in this patent there is no requirement for the included angle between a front imaging light path and a subsequent spectral dispersion light path and the angle of light incident on the DMD, and yet the problem of interference of spatial positions does not exist.

### SUMMARY

The invention aims to provide a spectral imaging method for acquiring target dual-band spectral information by utilizing the forward and backward deflection states of a DMD, which makes full use of the bidirectional deflection function of the DMD, and expands the application field of the DMD from single-band spectral imaging to dual-band spectral imaging. Meanwhile, to avoid spatial position interference between a front collimating light path and two spectral dispersion light paths, and to ensure the best imaging and spectral dispersion effects, some new constraint conditions are proposed in terms of the light path structure arrangement of a system. The whole system overcomes the defects of weak spectral energy, high detection difficulty of weak light signals, complex mechanical structure, and large volume and mass in the existing dual-band spectral imaging technology. Furthermore, it can meet the requirements of the current spectral imaging field for large detection information amount and high system compactness.

The light path composition of a dual-band spectral imaging system based on DMD provided by the invention is shown in FIG. 2, a working wave band 1 covers the range of λ1-λ3, and a working wave band 2 covers the range of λ4-λ6. The light paths mainly include a front collimating light path and two spectral dispersion light paths; the front collimating light path comprises a target 1, a front collimating lens assembly 2 and a DMD 3. Also the working wave band thereof covers a working wave band 1 and a working wave band 2. The spectral dispersion light path 4 mainly comprises a spectral dispersion element, a focusing element, and a detector. According to the selected deflection angle sizes of the DMD 3, whether a reflector is introduced to increase the included angle between the front collimating light path and the spectral dispersion light path 4 is considered to avoid the interference of spatial positions of components, and the working wave band range thereof is the working wave band 1. The spectral dispersion light path 5 mainly incorporates a spectral dispersion element, a focusing element, and a detector, meanwhile, according to the selected deflection angle sizes of the DMD 3, whether a reflector is introduced to increase the included angle between the front collimating light path and the spectral dispersion light path 5 is considered to avoid the interference of spatial positions of components, and the working wave band range thereof is the working wave band 2. The front collimating lens assembly 2 collects the incident light of the target 1 and makes it vertically incident on a working surface of the DMD 3 after being collimated; meanwhile, it is required that the optical axis of the front collimating lens assembly 2 passes through the center of the micromirror array surface of the DMD 3, and the DMD 3 is placed at the image surface of the front collimating lens assembly 2. When the micromirror of the DMD 3 is controlled to be in a forward deflection state, such as +12°, it reflects light into the spectral dispersion light path 4 to obtain the spectrum of the working wave band 1; it is required that the optical axis of the spectral dispersion light path 4 is parallel to the exit direction of the light in the forward deflection state and passes through the center of the micromirror array surface of the DMD 3; the micromirror of the DMD 3 is then switched to a backward deflection state, such as −12°, so as to reflect light into the spectral dispersion light path 5 to obtain the spectrum of the working wave band 2; and it is required that the optical axis of the spectral dispersion light path 5 is parallel to the exit direction of the light in the backward deflection state and passes through the center of the micromirror array surface of the DMD 3.

The front collimating lens assembly 2 is composed of a plurality of lenses, and is responsible for collimating the light emitted by the target 1 and making the light vertically incident on the DMD 3. The working wave band of the front collimating lens assembly should cover both the working wave band 1 and the working wave band 2.

The DMD 3 has various micromirror array sizes, such as 1920×1080 and 1024×768, and the micromirror deflection angles are mostly±12°, or 10°, ±17° etc. in other cases. As shown in FIG. 3, an image of the target 1 is divided by column into n scanning units by the micromirrors of the DMD 3, and the micromirrors in each scanning unit maintain the same deflection state; when a scanning unit is in an operating state, the micromirrors are controlled to deflect forward first and then deflect backward, as shown in FIG. 4, and reflect the perpendicularly incident light to two directions successively. The spectrum acquisition principle in a dual-band spectral imaging method based on a DMD is shown in FIG. 5. The target image is divided into columns by n micromirror scanning units of the DMD 3, and bidirectional scanning of the target image is realized by controlling the n micromirror scanning units to deflect forward and backward in sequence, so that detectors of the two spectral dispersion light paths are each provided with n dispersive spectral images, and spectral reconstruction is completed according to the principle that each spectral image corresponds to a different target image unit, thereby obtaining the dual-band spectral information of a target scene.

Referring to FIG. 5, the spectrum acquisition principle of the dual-band spectral imaging method based on the DMD comprises the following steps:

step 1: referring to FIG. 6, the first micromirror scanning unit of the DMD 3 is controlled to deflect forward to reflect the light of the first target image unit into the spectral dispersion light path 4;

step 2: referring to FIG. 6, after the reflected light of the first target image unit passes through the spectral dispersion light path 4, the spectrum thereof at the working wave band 1 is focused on the detector; the direction of spectral dispersion is defined as the X-axis direction, and the Y-axis direction perpendicular thereto is the spatial position direction; the spectrum of the first target image unit spreads out according to different wavelengths in sequence along the X-axis direction, and spectral components at different spatial positions are obtained in the Y-axis direction;

step 3: referring to FIG. 6, the detector in the spectral dispersion light path 4 records and stores a spectral image of the first target image unit at the working wave band 1, and the forward deflection of the first micromirror scanning unit is finished, thus the spectral imaging of the first target image unit at the working wave band 1 can be completed;

step 4: referring to FIG. 6, the first micromirror scanning unit of the DMD 3 is controlled to deflect backward to reflect the light of the first target image unit into the spectral dispersion light path 5;

step 5: referring to FIG. 6, after the reflected light of the first target image unit passes through the spectral dispersion light path 5, the spectrum thereof at the working wave band 2 is focused on the detector; the spectrum of the first target image unit spreads out according to different wavelengths in sequence along the X-axis direction, and spectral components at different spatial positions are obtained in the Y-axis direction;

step 6: referring to FIG. 6, the detector in the spectral dispersion light path 5 records and stores a spectral image of the first target image unit at the working wave band 2, and the backward deflection of the first micromirror scanning unit is finished, thus the spectral imaging of the first target image unit at the working wave band 2 can be completed;

step 7: referring to FIG. 7, the second micromirror scanning unit of the DMD 3 is controlled to deflect forward to reflect the light of the second target image unit into the spectral dispersion light path 4;

step 8: referring to FIG. 7, since a target image is shifted in the X-axis direction, the spectrum thereof at the working wave band 1 after dispersion is also shifted on the detector; the detector records and stores the spectral image at this moment, and the forward deflection of the second micromirror scanning unit is completed, thus the spectral imaging of the second target image unit at the working wave band 1 can be completed;

step 9: referring to FIG. 7, the second micromirror scanning unit of the DMD 3 is controlled to deflect backward to reflect the light of the second target image unit into the spectral dispersion light path 5;

step 10: referring to FIG. 7, since the target image is shifted in the X-axis direction, the spectrum thereof at the working wave band 2 after dispersion is also shifted on the detector; the detector records and stores the spectral image at this moment, and the backward deflection of the second micromirror scanning unit is completed, thus the spectral imaging of the second target image unit in the working wave band 2 can be completed;

step 11: the micromirror scanning units of the DMD 3 are controlled to deflect forward and backward in sequence, and corresponding spectral images are recorded and stored to complete the spectral imaging of the 3<rd>, 4<th> . . . (n−1)<th> target image units at the two working wave bands;

step 12: referring to FIG. 8, the n<th> micromirror scanning unit of the DMD 3 is controlled to deflect forward to reflect the light of the n<th> target image unit into the spectral dispersion light path 4;

step 13: referring to FIG. 8, since the spectra of different spatial positions are shifted in the X-axis direction, the spectral imaging of the entire spatial target at the working wave band 1 can be completed simply by ensuring that the detector of the spectral dispersion light path 4 can completely acquire the spectrum of the last target image unit at the working wave band 1;

step 14: referring to FIG. 8, the n<th> micromirror scanning unit of the DMD 3 is controlled to deflect backward to reflect the light of the n<th> target image unit into the spectral dispersion light path 5;

step 15: referring to FIG. 8, since the spectra of different spatial positions are shifted in the X-axis direction, the spectral imaging of the entire spatial target at the working wave band 2 can be simply completed by ensuring that the detector of the spectral dispersion light path 5 can completely acquire the spectrum of the last target image unit at the working wave band 2; step 16: data processing is carried out on the n spectral images collected by the detector of the spectral dispersion light path 4 and the detector of the spectral dispersion light path 5 respectively to obtain the two-dimensional spatial scene and the one-dimensional spectral information of the target, thus the dual-band spectral image fusion processing of the target can be completed.

Beneficial Effects

1. Strong light energy. After being reflected by the DMD, light signals enter the two spectral dispersion light paths respectively, thus the problems of light energy division and loss caused by beam splitters, spectroscopes and the like in the prior art can be ingeniously avoided.

2. Compact system. By means of the bidirectional deflection of the DMD, the slit scanning function and the light path dividing function of beam splitters and spectroscopes in other spectral imaging systems are realized at the same time, thus the number of light path components can be reduced and the structure of the system is simplified.

3. Adjustable spatial resolution. According to different usage requirements, the spatial resolution of the system can be adjusted by changing the number of micromirrors in the micromirror scanning unit.

### BRIEF DESCRIPTION OF THE DRAWINGS

FIG. 1 is a schematic diagram of forward and backward deflection of micromirrors of a DMD.

FIG. 2 shows the basic light path principle of a DMD-based dual-band spectral imaging method.

FIG. 3 is a schematic diagram showing a target image being divided by the DMD by column.

FIG. 4 is a schematic diagram of light emitting directions when DMD micromirrors deflect forward and backward.

FIG. 5 is a schematic diagram of the spectrum acquisition principle of the DMD-based dual-band spectral imaging method.

FIG. 6 is a schematic diagram of dual-band spectrum acquisition of the first target image unit.

FIG. 7 is a schematic diagram of dual-band spectrum acquisition of the second target image unit.

FIG. 8 is a schematic diagram of dual-band spectrum acquisition of the n<th> target image unit.

1. target; 2. front collimating lens assembly; 3. DMD; 4. spectral dispersion light path of working wave band 1; 5. spectral dispersion light path of working wave band 2.

FIG. 9 is a schematic diagram of light path composition of Embodiment 1.

1. target; 2. front collimating lens assembly; 3. DMD; 4. transmission grating; 5. focusing lens assembly; 6. detector: 7. transmission grating; 8. focusing lens assembly; 9. detector.

FIG. 10 is a schematic diagram of light path composition of Embodiment 2.

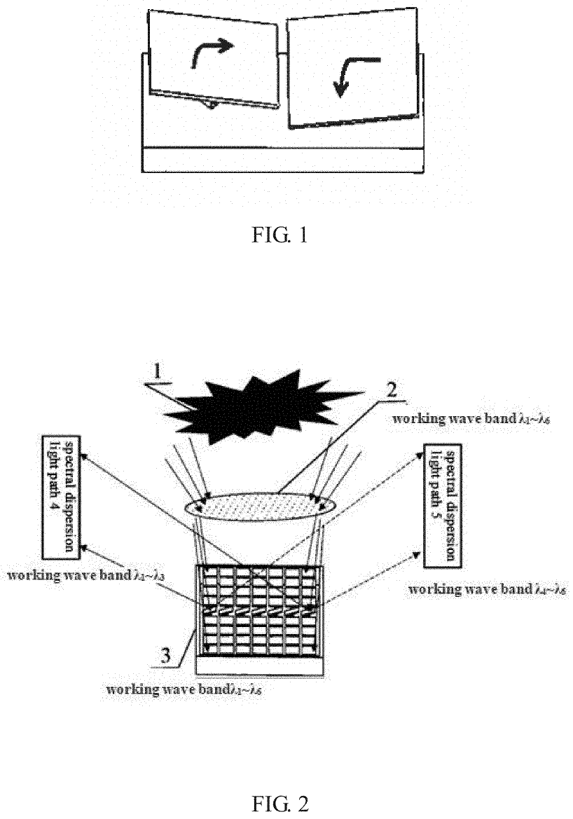

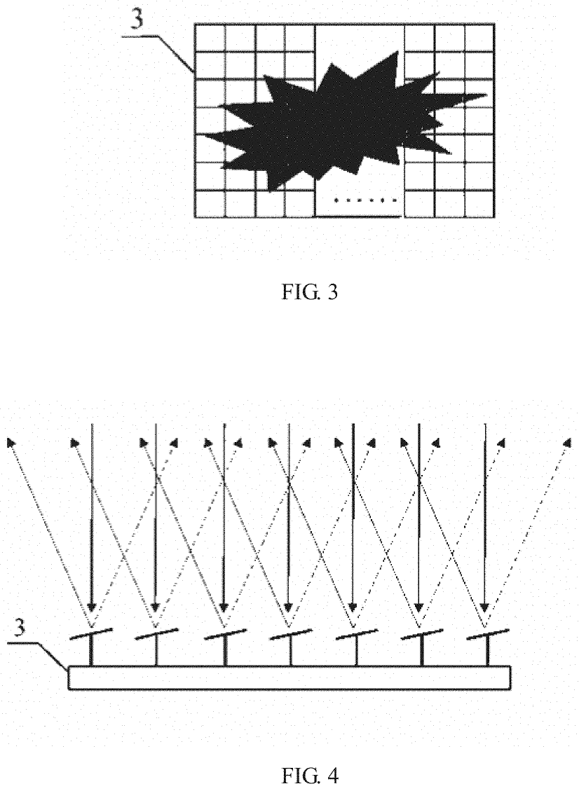

1. target; 2. front collimating lens assembly; 3. DMD; 4. reflector; 5. reflective grating; 6. focusing mirror; 7. detector; 8. reflector; 9. reflective grating; 10. focusing mirror; 11. detector.

### DESCRIPTION OF THE EMBODIMENTS

### Embodiment 1

The diagram of the light path composition of a dual-band spectral imaging system based on a DMD provided by the invention is shown in FIG. 9. A working wave band 1 within the range of λ1-λ3 is a visible light band, wherein λ1 is 0.4 μm, λ2 is 0.6 μm, and λ3 is 0.8 μm. A working wave band 2 within the range of λ4-λ6 is a near infrared band, wherein M is 0.9 μm, λ5 is 1.15 μm, and λ6 is 1.4 μm. The light path mainly comprises a front collimating light path and two spectral dispersion light paths, and specifically comprises a target 1, a front collimating lens assembly 2, a DMD 3, a transmission grating 4, a focusing lens assembly 5, a detector 6, a transmission grating 7, a focusing lens assembly 8 and a detector 9; the target 1 and the DMD 3 are respectively placed at the object surface and the image surface of the front collimating lens assembly 2, the front collimating lens assembly 2 collects the incident light of the target 1 and makes it vertically incident on the working surface of the DMD 3 after being collimated, the DMD 3 is placed at the image surface of the front collimating lens assembly 1, when a micromirror of the DMD 3 is controlled to be in a forward deflection state, it reflects light onto the transmission grating 4, and the spectrum dispersed by the transmission grating 4 is imaged to the detector 6 through the focusing lens assembly 5; and then the micromirror of the DMD 3 is switched to a backward deflection state, it reflects light onto the transmission grating 7, and the spectrum dispersed by the transmission grating 7 is imaged to the detector 9 through the focusing lens assembly 8. An angle of 90° is formed between the optical axis of the collimating lens assembly 2 and the base surface of the DMD 3, the optical axis of the transmission grating 4 is parallel to the light emitting direction when the DMD 3 deflects forward, and passes through the center of the micromirror array surface of the DMD 3, and the optical axis of the transmission grating 7 is parallel to the light emitting direction when the DMD 3 deflects backward, and passes through the center of the micromirror array surface of the DMD 3. The optical axis of the focusing lens assembly 5 is parallel to a primary ray after dispersion by the transmission grating 4, detector 6 is disposed at an image surface of the focusing lens assembly 5, the optical axis of the focusing lens assembly 8 is parallel to a primary ray after dispersion by the transmission grating 7, and the detector 9 is disposed at the image surface of the focusing lens assembly 8.

The front collimating lens assembly 2 is composed of a plurality of lenses, and is responsible for collimating the light emitted by the target 1 to ensure the light vertically incident on the DMD 3. The working wave band of the front collimating lens assembly should cover both the working wave band 1 and the working wave band 2.

The micromirror array of the DMD 3 is determined to be 1024×768, and the micromirror deflection angle is determined to be a large deflection angle, that is ±17°. The DMD 3 divides a target image into 1024 micromirror scanning units by columns, each micromirror scanning unit contains 1×768 micromirrors. Through controlling the forward and backward deflection of each micromirror scanning unit, each target image unit can be reflected into the two spectral dispersion light paths respectively. The transmission grating 4 is a blazed grating, which is responsible for dispersing the light which is reflected by the forward deflection of the DMD 3, and covers a working wave band of 0.4-0.8 μm with a blazed wavelength of 0.6 μm.

The focusing lens assembly 5 is responsible for focusing and imaging the spectrum dispersed by the transmission grating 4. The focusing lens assembly 5 consists of a plurality of lenses, and the materials and sizes of these lenses are determined according to the visible light band.

The detector 6 is a CCD camera with a pixel size of 3.45 μm×3.45 μm and a pixel number of 2448×2050.

The transmission grating 7 is a blazed grating with a working wave band of 0.9-1.4 μm with a blazed wavelength of 1.15 μm.

The focusing lens assembly 8 is responsible for focusing and imaging the spectrum after dispersion by the transmission grating 7. The focusing lens assembly 8 consists of a plurality of lenses, and the materials and sizes of these lenses are determined according to the near infrared band.

The detector 9 is a near infrared detector with a pixel size of 15 μm×15 μm and a pixel number of 640×512.

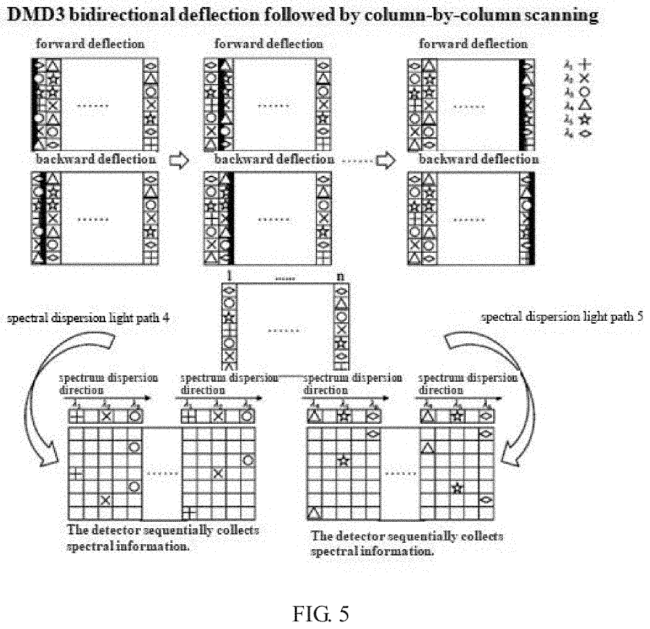

The spectrum acquisition principle in a dual-band spectral imaging method based on a DMD proposed by the embodiment is shown in FIG. 5, wherein n=1024. The target image is divided into columns by 1024 micromirror scanning units of the DMD 3, and bidirectional scanning of the target image is realized by controlling each micromirror scanning unit to deflect forward and backward in sequence, so that the detector 6 and the detector 9 are each provided with 1024 dispersive spectral images, and spectral reconstruction is completed according to the principle that each spectral image corresponds to a different target image unit, thereby the dual-band spectral information of a target scene can be obtained.

Referring to FIG. 5, the spectrum acquisition principle of a dual-band spectral imaging method based on a DMD proposed by the invention comprises the following steps:

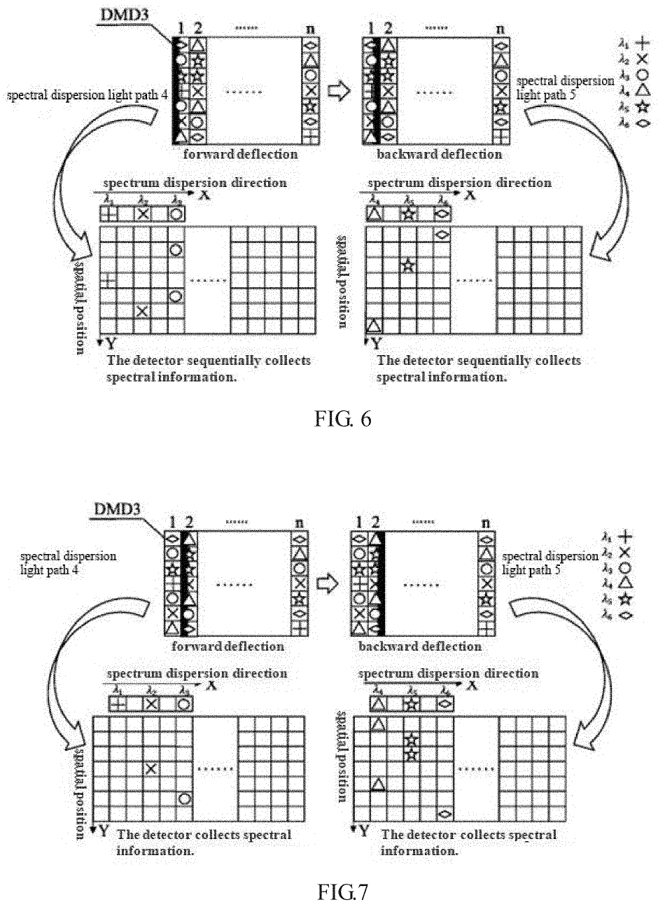

step 1: referring to FIG. 6, the first micromirror scanning unit of the DMD 3 is controlled to deflect forward to reflect the light of the first target image unit into the spectral dispersion light path 1;

step 2: referring to FIG. 6, after the reflected light of the first target image unit passes through the spectral dispersion light path 1, the spectrum thereof at the working wave band 1 is focused on the detector 6; the direction of spectral dispersion is defined as the X-axis direction, and the Y-axis direction perpendicular thereto is the spatial position direction; the spectrum of the first target image unit spreads out according to different wavelengths in sequence along the X-axis direction, and spectral components at different spatial positions are obtained in the Y-axis direction;

step 3: referring to FIG. 6, the detector 6 records and stores a spectral image of the first target image unit at the working wave band 1, and the forward deflection of the first micromirror scanning unit is finished, thus the spectral imaging of the first target image unit at the working wave band 1 can be completed;

step 4: referring to FIG. 6, the first micromirror scanning unit of the DMD 3 is controlled to deflect backward to reflect the light of the first target image unit into the spectral dispersion light path 2;

step 5: referring to FIG. 6, after the reflected light of the first target image unit passes through the spectral dispersion light path 2, the spectrum thereof at the working wave band 2 is focused on the detector 9; the spectrum of the first target image unit spreads out according to different wavelengths in sequence along the X-axis direction, and spectral components at different spatial positions are obtained in the Y-axis direction;

step 6: referring to FIG. 6, the detector 9 records and stores a spectral image of the first target image unit at the working wave band 2, and the backward deflection of the first micromirror scanning unit is finished, thus the spectral imaging of the first target image unit at the working wave band 2 can be completed;

step 7: referring to FIG. 7, the second micromirror scanning unit of the DMD 3 is controlled to deflect forward to reflect the light of the second target image unit into the spectral dispersion light path 1;

step 8: referring to FIG. 7, since a target image is shifted in the X-axis direction, the spectrum thereof at the working wave band 1 after dispersion is also shifted on the detector 6; the detector 6 records and stores the spectral image at this moment, and the forward deflection of the second micromirror scanning unit is completed, thus the spectral imaging of the second target image unit at the working wave band 1 can be completed;

step 9: referring to FIG. 7, the second micromirror scanning unit of the DMD 3 is controlled to deflect backward to reflect the light of the second target image unit into the spectral dispersion light path 2;

step 10: referring to FIG. 7, since the target image is shifted in the X-axis direction, the spectrum thereof at the working wave band 2 after dispersion is also shifted on the detector 9; the detector 9 records and stores the spectral image at this moment, and the backward deflection of the second micromirror scanning unit is completed, thus the spectral imaging of the second target image unit in the working wave band 2 can be completed:

step 11: the micromirror scanning units of the DMD 3 are controlled to deflect forward and backward in sequence, and corresponding spectral images are recorded and stored to complete the spectral imaging of the 3<rd>, 4<th> . . . 1023<rd> target image units at the two working wave bands;

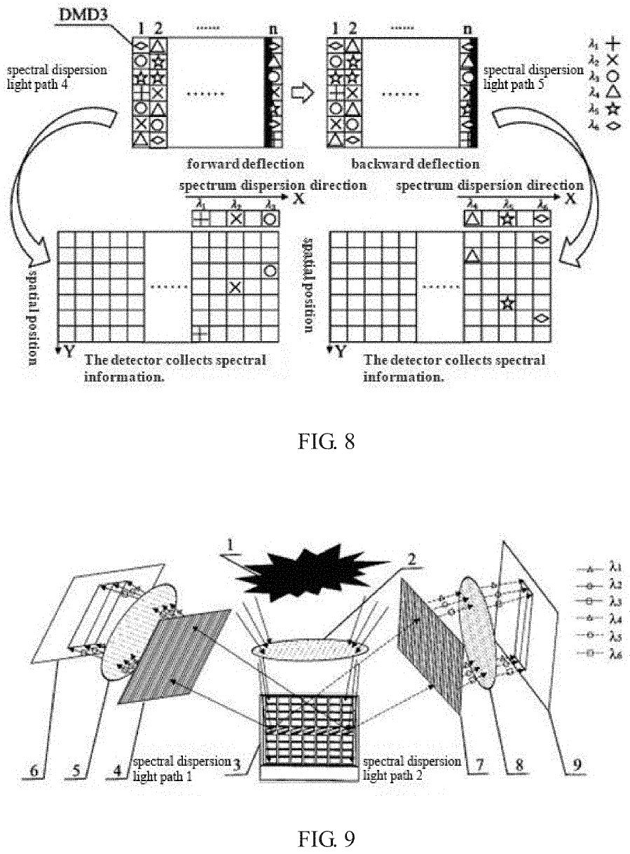

step 12: referring to FIG. 8, the 1024<th> micromirror scanning unit of the DMD 3 is controlled to deflect forward to reflect the light of the 1024<th> target image unit into the spectral dispersion light path 1;

step 13: referring to FIG. 8, since the spectra of different spatial positions are shifted in the X-axis direction, the spectral imaging of the entire spatial target at the working wave band 1 be completely simplified through ensuring that the detector 6 can completely acquire the spectrum of the last target image unit at the working wave band 1;

step 14: referring to FIG. 8, the 1024<th> micromirror scanning unit of the DMD 3 is controlled to deflect backward to reflect the light of the 1024<th> target image unit into the spectral dispersion light path 2;

step 15: referring to FIG. 8, since the spectra of different spatial positions are shifted in the X-axis direction, the spectral imaging of the entire spatial target at the working wave band 2 can be completed simply by ensuring that the detector 9 can completely acquire the spectrum of the last target image unit at the working wave band 2;

step 16: data processing is carried out on the 1024 spectral images collected by the detector 6 and the detector 9 respectively to obtain the two-dimensional spatial scene and the one-dimensional spectral information of the target, thus the dual-band spectral imaging of the target can be completed.

### Embodiment 2

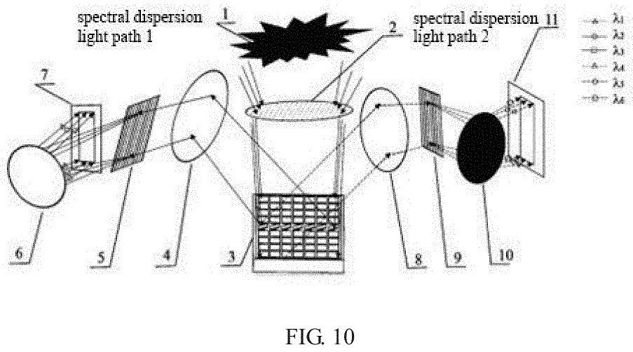

The diagram of the light path composition of a dual-band spectral imaging system based on a DMD provided by the invention is shown in FIG. 10. A working wave band 1 within the range of λ1-λ3 is a visible light band, wherein λ1 is 0.4 μm, λ2 is 0.6 μm, and λ3 is 0.8 μm. A working wave band 2 within the range of λ4-6 is a short wave infrared band, wherein 4 is 1.4 μm, λ5 is 1.95 μm, and λ6 is 2.5 μm. The light path mainly comprises a front collimating light path and two spectral dispersion light paths 1 and 2, and specifically comprises a target 1, a front collimating lens assembly 2, a DMD 3, a reflector 4, a reflective grating 5, a focusing mirror 6, a detector 7, a reflector 8, a reflective grating 9, a focusing mirror 10 and a detector 11. The target 1 and the DMD 3 are respectively placed at the object surface and the image surface of the front collimating lens assembly 2, the front collimating lens assembly 2 collects the incident light of the target 1 and makes it vertically incident on the working surface of the DMD 3 after being collimated, the DMD 3 is placed at the image surface of the front collimating lens assembly 1, when a micromirror of the DMD 3 is controlled to be in a forward deflection state, it reflects light into the spectral dispersion light path 1 for spectral dispersion and spectrum acquisition; and then the micromirror of the DMD 3 is switched to a backward deflection state, it reflects light into the spectral dispersion light path 2 for spectral dispersion and spectrum acquisition. An angle of 90° is formed between the optical axis of the collimating lens assembly 2 and the base surface of the DMD 3, the incident optical axis of the reflector 4 is parallel to the light emitting direction when the DMD 3 deflects forward, and passes through the center of a micromirror array surface of the DMD 3, the center of the reflective grating 5 passes through the exit optical axis of the reflector 4, the center of the focusing mirror 6 is parallel to the primary ray after dispersion by the reflective grating 5, and the detector 7 is disposed at an image surface of the focusing mirror 6; and the incident optical axis of the reflector 8 is parallel to the light emitting direction when the DMD 3 deflects forward, and passes through the center of the micromirror array surface of the DMD 3, the center of the reflective grating 9 passes through the exit optical axis of the reflector 8, the center of the focusing mirror 10 is parallel to the primary ray after dispersion by the reflective grating 9, and the detector 11 is disposed at the image surface of the focusing mirror 10.

The front collimating lens assembly 2 is composed of a plurality of lenses, and is responsible for collimating the light from the target 1 and making the light vertically incident on the DMD 3. The working wave band of the front collimating lens assembly should cover both the working wave band 1 and the working wave band 2.

The micromirror array of the DMD 3 is determined to be 1920×1080, and the micromirror deflection angle is determined to be ±12°. The DMD 3 divides a target image into 960 micromirror scanning units by columns, each micromirror scanning unit contains 2×1080 micromirrors, and by controlling the forward and backward deflection of each micromirror scanning unit, each target image unit can be reflected into the two spectral dispersion light paths respectively.

The reflector 4 is a plane reflector or a spherical reflector, and is responsible for reflecting the light reflected by forward deflection of the DMD 3 back to the reflective grating 5, so as to prevent spatial position interference of components in the collimating light path and the spectral dispersion light path 1, and the deflection angle thereof can be selected according to actual conditions, 20° in this example.

The reflective grating 5 is a blazed grating, which is responsible for dispersing the light which is reflected by the reflector 4, and has a working wave band of 0.4-0.8 μm and a blazed wavelength of 0.6 μm.

The focusing mirror 6 is a concave spherical reflector and is responsible for focusing and imaging the spectrum after dispersion by the reflective grating 5. The working wave band of the focusing mirror 6 is visible light band.

The detector 7 is a CCD camera with a pixel size of 3.45 μm×3.45 μm and a pixel number of 2448×2050.

The reflector 8 is a plane reflector or a spherical reflector, and is responsible for reflecting the light reflected by backward deflection of the DMD 3 back to the reflective grating 9, so as to prevent spatial position interference of components in the collimating light path and the spectral dispersion light path 2, and the deflection angle thereof can be selected according to actual conditions, 15° in this example.

The reflective grating 9 is a blazed grating, which is responsible for dispersing the light which is reflected by the reflector 8, and owns the working wave band of 1.4-2.5 μm and the blazed wavelength of 1.95 μm.

The focusing mirror 10 is a concave spherical reflector and is responsible for focusing and imaging the spectrum after dispersion by the reflective grating 5. The working wave band of the focusing mirror 10 is short wave infrared band.

The detector 11 is a short wave infrared detector with a pixel size of 15 μm×15 μm and a pixel number of 640×512.

The spectrum acquisition principle in a dual-band spectral imaging method based on a DMD proposed by the embodiment is shown in FIG. 5, wherein n=960. The target image is divided into columns by 960 micromirror scanning units of the DMD 3, and bidirectional scanning of the target image is realized by controlling each micromirror scanning unit to deflect forward and backward in sequence, so that the detector 7 and the detector 11 are each provided with 960 dispersive spectral images, and spectral reconstruction is completed according to the principle that each spectral image corresponds to a different target image unit, thereby the dual-band spectral information of a target scene is obtained.

Referring to FIG. 5, the spectrum acquisition principle of a dual-band spectral imaging method based on a DMD proposed by the invention comprises the following steps:

step 1: referring to FIG. 6, the first micromirror scanning unit of the DMD 3 is controlled to deflect forward to reflect the light of the first target image unit into the spectral dispersion light path 1;

step 2: referring to FIG. 6, after the reflected light of the first target image unit passes through the spectral dispersion light path 1, the spectrum thereof at the working wave band 1 is focused on the detector 7; the direction of spectral dispersion is defined as the X-axis direction, and the Y-axis direction perpendicular thereto is the spatial position direction; the spectrum of the first target image unit spreads out according to different wavelengths in sequence along the X-axis direction, and spectral components at different spatial positions are obtained in the Y-axis direction;

step 3: referring to FIG. 6, the detector 7 records and stores a spectral image of the first target image unit at the working wave band 1, and the forward deflection of the first micromirror scanning unit is finished, thus the spectral imaging of the first target image unit at the working wave band 1 can be completed;

step 4: referring to FIG. 6, the first micromirror scanning unit of the DMD 3 is controlled to deflect backward to reflect the light of the first target image unit into the spectral dispersion light path 2;

step 5: referring to FIG. 6, after the reflected light of the first target image unit passes through the spectral dispersion light path 2, the spectrum thereof at the working wave band 2 is focused on the detector 11; the spectrum of the first target image unit spreads out according to different wavelengths in sequence along the X-axis direction, and spectral components at different spatial positions are obtained in the Y-axis direction;

step 6: referring to FIG. 6, the detector 11 records and stores a spectral image of the first target image unit at the working wave band 2, and the backward deflection of the first micromirror scanning unit is finished, thus the spectral imaging of the first target image unit at the working wave band 2 can be completed;

step 7: referring to FIG. 7, the second micromirror scanning unit of the DMD 3 is controlled to deflect forward to reflect the light of the second target image unit into the spectral dispersion light path 1;

step 8: referring to FIG. 7, since a target image is shifted in the X-axis direction, the spectrum thereof at the working wave band 1 after dispersion is also shifted on the detector 7, the detector 7 records and stores the spectral image at this moment, and the forward deflection of the second micromirror scanning unit is completed, thus the spectral imaging of the second target image unit at the working wave band 1 can be completed;

step 9: referring to FIG. 7, the second micromirror scanning unit of the DMD 3 is controlled to deflect backward to reflect the light of the second target image unit into the spectral dispersion light path 2;

step 10: referring to FIG. 7, since the target image is shifted in the X-axis direction, the spectrum thereof at the working wave band 2 after dispersion is also shifted on the detector 11; the detector 11 records and stores the spectral image at this moment, and the backward deflection of the second micromirror scanning unit is completed, thus the spectral imaging of the second target image unit in the working wave band 2 can be completed;

step 11: the micromirror scanning units of the DMD 3 are controlled to deflect forward and backward in sequence, and corresponding spectral images are recorded and stored to complete the spectral imaging of the 3<rd>, 4<th> . . . 959<rd> target image units at the two working wave bands:

step 12: referring to FIG. 8, the 960<th> micromirror scanning unit of the DMD 3 is controlled to deflect forward to reflect the light of the 960<th> target image unit into the spectral dispersion light path 1;

step 13: referring to FIG. 8, since the spectra of different spatial positions are shifted in the X-axis direction, the spectral imaging of the entire spatial target at the working wave band 1 can be completed simply by ensuring that the detector 7 can completely acquire the spectrum of the last target image unit at the working wave band 1;

step 14: referring to FIG. 8, the 960<th> micromirror scanning unit of the DMD 3 is controlled to deflect backward to reflect the light of the 960<th> target image unit into the spectral dispersion light path 2;

step 15: referring to FIG. 8, since the spectra of different spatial positions are shifted in the X-axis direction, the spectral imaging of the entire spatial target at the working wave band 2 can be completed simply by ensuring that the detector 11 can completely acquire the spectrum of the last target image unit at the working wave band 2;

step 16: data processing is carried out on the 960 spectral images collected by the detector 7 and the detector 11 respectively to obtain the two-dimensional spatial scene and the one-dimensional spectral information of the target, thus the dual-band spectral imaging of the target can be completed.

What is claimed is:

1. A dual-band spectral imaging system based on a digital micromirror device (DMD), characterized by mainly comprising a front collimating light path and two spectral dispersion light paths, wherein the front collimating light path comprises a target 1, a front collimating lens assembly 2 and a DMD 3, and the working wave band thereof covers a working wave band 1 and a working wave band 2; the spectral dispersion light path 4 works at the working wave band 1; the spectral dispersion light path 5 works at the working wave band 2; the front collimating lens assembly 2 collects the incident light of the target 1 and makes it vertically incident on the working surface of the DMD 3 after being collimated; meanwhile, it is required that the optical axis of the front collimating lens assembly 2 passes through the center of the micromirror array surface of the DMD 3, and the DMD 3 is placed at the image surface of the front collimating lens assembly 2; when a micromirror of the DMD 3 is controlled to be in a forward deflection state, it reflects light into the spectral dispersion light path 4 to obtain the spectrum of the working wave band 1; it is required that the optical axis of the spectral dispersion light path 4 is parallel to the exit direction of the light in the forward deflection state and passes through the center of the micromirror array surface of the DMD 3; the micromirror of the DMD 3 is then switched to a backward deflection state, so as to reflect light into the spectral dispersion light path 5 to obtain the spectrum of the working wave band 2; it is required that an optical axis of the spectral dispersion light path 5 is parallel to the exit direction of the light in the backward deflection state and passes through the center of the micromirror array surface of the DMD 3; and the front collimating lens assembly 2 is composed of a plurality of lenses, and is responsible for collimating the light emitted by the target 1 and making the light vertically incident on the DMD 3, and the working wave band thereof should cover both the working wave band 1 and the working wave band 2.

2. The dual-band spectral imaging system based on the DMD according to claim 1, characterized in that the spectral dispersion light path 4 and the spectral dispersion light path 5 each comprise a spectral dispersion element, a focusing element and a detector.

3. The dual-band spectral imaging system based on the DMD according to claim 1, characterized in that a reflector is arranged between the DMD 3 and each of two spectral dispersion light paths, so that the light reflected by the forward and backward deflection of the DMD 3 enters the two spectral dispersion light paths respectively after being reflected by the corresponding reflectors, and the interference of spatial positions of components is avoided.

4. A dual-band spectral imaging method based on the system according to claim 1, comprising the following steps: step 1: the first micromirror scanning unit of the DMD 3 is controlled to deflect forward to reflect the light of the first target image unit into the spectral dispersion light path 4;
step 2: after the reflected light of the first target image unit passes through the spectral dispersion light path 4, the spectrum thereof at the working wave band 1 is focused on the detector; the direction of spectral dispersion is defined as the X-axis direction, and the Y-axis direction perpendicular thereto is the spatial position direction; the spectrum of the first target image unit spreads out according to different wavelengths in sequence along the X-axis direction, and spectral components at different spatial positions are obtained in the Y-axis direction;
step 3: the detector in the spectral dispersion light path 4 records and stores a spectral image of the first target image unit within the working wave band 1, and the forward deflection of the first micromirror scanning unit is finished, thus the spectral imaging of the first target image unit is completed within the working wave band 1;
step 4: the first micromirror scanning unit of the DMD 3 is controlled to deflect backward to reflect the light of the first target image unit into the spectral dispersion light path 5;
step 5: after the reflected light of the first target image unit passes through the spectral dispersion light path 5, the spectrum thereof within the working wave band 2 is focused on the detector; the spectrum of the first target image unit spread outs according to different wavelengths in sequence along the X-axis direction, and the spectral components at different spatial positions are acquired in the Y-axis direction;
step 6: the detector in the spectral dispersion light path 5 records and stores a spectral image of the first target image unit at the working wave band 2, and the backward deflection of the first micromirror scanning unit is fulfilled, thus the spectral imaging of the first target image unit at the working wave band 2 can be completed;
step 7: the second micromirror scanning unit of the DMD 3 is controlled to deflect forward to reflect the light of the second target image unit into the spectral dispersion light path 4;
step 8: since a target image is shifted in the X-axis direction, the spectrum thereof at the working wave band 1 after dispersion is also shifted on the detector; the detector records and stores the spectral image at this moment, and the forward deflection of the second micromirror scanning unit is completed, thus the spectral imaging of the second target image unit at the working wave band 1 can be completed;
step 9: the second micromirror scanning unit of the DMD 3 is controlled to deflect backward to reflect the light of the second target image unit into the spectral dispersion light path 5;
step 10: since the target image is shifted in the X-axis direction, the spectrum thereof at the working wave band 2 after dispersion is also shifted on the detector; the detector records and stores the spectral image at this moment, and the backward deflection of the second micromirror scanning unit is completed, thus the spectral imaging of the second target image unit in the working wave band 2 can be completed;
step 11: the micromirror scanning units of the DMD 3 are controlled to deflect forward and backward in sequence, and corresponding spectral images are recorded and stored to complete the spectral imaging of the 3<rd>, 4<th> . . . (n−1)<th> target image units at the two working wave bands;
step 12: the n<th> micromirror scanning unit of the DMD 3 is controlled to deflect forward to reflect the light of the n<th> target image unit into the spectral dispersion light path 4;
step 13: since the spectra of different spatial positions are shifted in the X-axis direction, the spectral imaging of the entire spatial target at the working wave band 1 can be completed simply by ensuring that the detector of the spectral dispersion light path 4 can completely acquire the spectrum of the last target image unit at the working wave band 1;
step 14: the n<th> micromirror scanning unit of the DMD 3 is controlled to deflect backward to reflect the light of the n<th> target image unit into the spectral dispersion light path 5;
step 15: since the spectra of different spatial positions are shifted in the X-axis direction, the spectral imaging of the entire spatial target at the working wave band 2 can be completed simply by ensuring that the detector of the spectral dispersion light path 5 can completely acquire the spectrum of the last target image unit at the working wave band 2;
step 16: data processing is carried out on the n spectral images collected by the detector of the spectral dispersion light path 4 and the detector of the spectral dispersion light path 5 respectively to obtain the two-dimensional spatial scene and the one-dimensional spectral information of the target, thus the dual-band spectral image fusion processing of the target can be completed.

5. A dual-band spectral imaging method based on the system according to claim 2, comprising the following steps: step 1: the first micromirror scanning unit of the DMD 3 is controlled to deflect forward to reflect the light of the first target image unit into the spectral dispersion light path 4;
step 2: after the reflected light of the first target image unit passes through the spectral dispersion light path 4, the spectrum thereof at the working wave band 1 is focused on the detector; the direction of spectral dispersion is defined as the X-axis direction, and the Y-axis direction perpendicular thereto is the spatial position direction; the spectrum of the first target image unit spreads out according to different wavelengths in sequence along the X-axis direction, and spectral components at different spatial positions are obtained in the Y-axis direction;
step 3: the detector in the spectral dispersion light path 4 records and stores a spectral image of the first target image unit within the working wave band 1, and the forward deflection of the first micromirror scanning unit is finished, thus the spectral imaging of the first target image unit is completed within the working wave band 1;
step 4: the first micromirror scanning unit of the DMD 3 is controlled to deflect backward to reflect the light of the first target image unit into the spectral dispersion light path 5;
step 5: after the reflected light of the first target image unit passes through the spectral dispersion light path 5, the spectrum thereof within the working wave band 2 is focused on the detector; the spectrum of the first target image unit spread outs according to different wavelengths in sequence along the X-axis direction, and the spectral components at different spatial positions are acquired in the Y-axis direction;
step 6: the detector in the spectral dispersion light path 5 records and stores a spectral image of the first target image unit at the working wave band 2, and the backward deflection of the first micromirror scanning unit is fulfilled, thus the spectral imaging of the first target image unit at the working wave band 2 can be completed;
step 7: the second micromirror scanning unit of the DMD 3 is controlled to deflect forward to reflect the light of the second target image unit into the spectral dispersion light path 4;
step 8: since a target image is shifted in the X-axis direction, the spectrum thereof at the working wave band 1 after dispersion is also shifted on the detector; the detector records and stores the spectral image at this moment, and the forward deflection of the second micromirror scanning unit is completed, thus the spectral imaging of the second target image unit at the working wave band 1 can be completed;
step 9: the second micromirror scanning unit of the DMD 3 is controlled to deflect backward to reflect the light of the second target image unit into the spectral dispersion light path 5;
step 10: since the target image is shifted in the X-axis direction, the spectrum thereof at the working wave band 2 after dispersion is also shifted on the detector; the detector records and stores the spectral image at this moment, and the backward deflection of the second micromirror scanning unit is completed, thus the spectral imaging of the second target image unit in the working wave band 2 can be completed;
step 11: the micromirror scanning units of the DMD 3 are controlled to deflect forward and backward in sequence, and corresponding spectral images are recorded and stored to complete the spectral imaging of the 3<rd>, 4<th> . . . (n−1)<th> target image units at the two working wave bands;
step 12: the n<th> micromirror scanning unit of the DMD 3 is controlled to deflect forward to reflect the light of the n<th> target image unit into the spectral dispersion light path 4;
step 13: since the spectra of different spatial positions are shifted in the X-axis direction, the spectral imaging of the entire spatial target at the working wave band 1 can be completed simply by ensuring that the detector of the spectral dispersion light path 4 can completely acquire the spectrum of the last target image unit at the working wave band 1;
step 14: the n<th> micromirror scanning unit of the DMD 3 is controlled to deflect backward to reflect the light of the n<th> target image unit into the spectral dispersion light path 5;
step 15: since the spectra of different spatial positions are shifted in the X-axis direction, the spectral imaging of the entire spatial target at the working wave band 2 can be completed simply by ensuring that the detector of the spectral dispersion light path 5 can completely acquire the spectrum of the last target image unit at the working wave band 2;
step 16: data processing is carried out on the n spectral images collected by the detector of the spectral dispersion light path 4 and the detector of the spectral dispersion light path 5 respectively to obtain the two-dimensional spatial scene and the one-dimensional spectral information of the target, thus the dual-band spectral image fusion processing of the target can be completed.

6. A dual-band spectral imaging method based on the system according to claim 3, comprising the following steps: step 1: the first micromirror scanning unit of the DMD 3 is controlled to deflect forward to reflect the light of the first target image unit into the spectral dispersion light path 4;
step 2: after the reflected light of the first target image unit passes through the spectral dispersion light path 4, the spectrum thereof at the working wave band 1 is focused on the detector: the direction of spectral dispersion is defined as the X-axis direction, and the Y-axis direction perpendicular thereto is the spatial position direction; the spectrum of the first target image unit spreads out according to different wavelengths in sequence along the X-axis direction, and spectral components at different spatial positions are obtained in the Y-axis direction;
step 3: the detector in the spectral dispersion light path 4 records and stores a spectral image of the first target image unit within the working wave band 1, and the forward deflection of the first micromirror scanning unit is finished, thus the spectral imaging of the first target image unit is completed within the working wave band 1;
step 4: the first micromirror scanning unit of the DMD 3 is controlled to deflect backward to reflect the light of the first target image unit into the spectral dispersion light path 5;
step 5: after the reflected light of the first target image unit passes through the spectral dispersion light path 5, the spectrum thereof within the working wave band 2 is focused on the detector; the spectrum of the first target image unit spread outs according to different wavelengths in sequence along the X-axis direction, and the spectral components at different spatial positions are acquired in the Y-axis direction;
step 6: the detector in the spectral dispersion light path 5 records and stores a spectral image of the first target image unit at the working wave band 2, and the backward deflection of the first micromirror scanning unit is fulfilled, thus the spectral imaging of the first target image unit at the working wave band 2 can be completed;
step 7: the second micromirror scanning unit of the DMD 3 is controlled to deflect forward to reflect the light of the second target image unit into the spectral dispersion light path 4;
step 8: since a target image is shifted in the X-axis direction, the spectrum thereof at the working wave band 1 after dispersion is also shifted on the detector; the detector records and stores the spectral image at this moment, and the forward deflection of the second micromirror scanning unit is completed, thus the spectral imaging of the second target image unit at the working wave band 1 can be completed;
step 9: the second micromirror scanning unit of the DMD 3 is controlled to deflect backward to reflect the light of the second target image unit into the spectral dispersion light path 5;
step 10: since the target image is shifted in the X-axis direction, the spectrum thereof at the working wave band 2 after dispersion is also shifted on the detector; the detector records and stores the spectral image at this moment, and the backward deflection of the second micromirror scanning unit is completed, thus the spectral imaging of the second target image unit in the working wave band 2 can be completed;
step 11: the micromirror scanning units of the DMD 3 are controlled to deflect forward and backward in sequence, and corresponding spectral images are recorded and stored to complete the spectral imaging of the 3<rd>, 4<th> . . . (n−1)<th> target image units at the two working wave bands;
step 12: the n<th> micromirror scanning unit of the DMD 3 is controlled to deflect forward to reflect the light of the n<th> target image unit into the spectral dispersion light path 4;
step 13: since the spectra of different spatial positions are shifted in the X-axis direction, the spectral imaging of the entire spatial target at the working wave band 1 can be completed simply by ensuring that the detector of the spectral dispersion light path 4 can completely acquire the spectrum of the last target image unit at the working wave band 1;
step 14: the n<th> micromirror scanning unit of the DMD 3 is controlled to deflect backward to reflect the light of the n<th> target image unit into the spectral dispersion light path 5;
step 15: since the spectra of different spatial positions are shifted in the X-axis direction, the spectral imaging of the entire spatial target at the working wave band 2 can be completed simply by ensuring that the detector of the spectral dispersion light path 5 can completely acquire the spectrum of the last target image unit at the working wave band 2;
step 16: data processing is carried out on the n spectral images collected by the detector of the spectral dispersion light path 4 and the detector of the spectral dispersion light path 5 respectively to obtain the two-dimensional spatial scene and the one-dimensional spectral information of the target, thus the dual-band spectral image fusion processing of the target can be completed.
